(19) United States
(12) Patent Application Publication
(10) Pub. No.: US 2013/0337121 A1
(43) Pub. Date: Dec. 19, 2013

(54) DEVICES AND METHODS FOR PERSERVING FOOD

(71) Applicants: Shigeo Sugano, Kyoto-shi (JP); Takahisa Kusuura, Kawasaki-shi (JP)

(72) Inventors: Shigeo Sugano, Kyoto-shi (JP); Takahisa Kusuura, Kawasaki-shi (JP)

(73) Assignee: EMPIRE TECHNOLOGY DEVELOPMENT LLC, Wilmington, DE (US)

(21) Appl. No.: 13/583,819

(22) PCT Filed: Jun. 14, 2012
(86) PCT No.: PCT/JP12/03891

§ 371 Date: Sep. 10, 2012

(51) Int. Cl. B65B 55/00; A23L 3/26

(52) U.S. Cl. 426/232; 99/451; 426/248

(57) ABSTRACT

Devices and methods for preserving food are provided. The device comprises a container configured to contain the food, a photocatalyst layer disposed in the container, a light source attached to the container, and a coil configured to receive radio waves or electromagnetic radiation and provide an electric current to the light source, the coil being attached to the container.

### TECHNICAL FIELD

Devices and methods for preserving food are disclosed.

### BACKGROUND

Some refrigerators, storage cabinets, and containers that are used by distributors or house keepers have a circulator to circulate ozone or reactive oxygen species to degrade ethylene gas emitted from fruits or have a light source for emitting ultra violet (UV) light to sterilize foods. By degrading the ethylene gas and sterilizing the foods, it is possible to improve a storage environment, maintain freshness of the foods, keep the foods from rotting and extend the expiration date of the foods.

However, the food in the market place is generally packaged or stored in a preservation container to protect the food, to prevent odor from spreading to other foods, and to keep moisture around the food. Such preservation container does not allow the ozone or the reactive oxygen species and the UV light to enter inside the container. Therefore, even if the refrigerators as mentioned are used, it is difficult to maintain freshness of packaged foods. In addition, it is difficult to remove the ethylene gas accumulated in the package by the refrigerators as mentioned above.

### SUMMARY

An aspect of the present disclosure relates to a device for preserving food. The device comprises: a container configured to contain the food; a photocatalyst layer disposed in the container; a light source attached to the container; and a coil configured to receive radio waves or electromagnetic radiation and provide an electric current to the light source, the coil being attached to the container.

Another aspect of the present, disclosure relates to a method for preserving food. The method comprises: providing a container wherein a photocatalyst is disposed in the container and a light source and a coil connected to the light source are attached to the container; putting the food into the container; providing the coil with radio waves or electromagnetic radiation; providing an electric current, to the light, source from the coil; and emitting light from the light source to generate a radical from the photo-catalyst layer exposed to the light.

Yet another aspect of the present disclosure relates to a device for preserving food. The device comprises: a container configured to contain the food; a light source attached to the container and emitting sterilizing light; and a coil configured to receive radio waves or an electromagnetic radiation and provide an electric current to the light source, the coil being attached to the container.

Yet another aspect of the present disclosure relates to a method for preserving food. The method comprises: providing a container wherein a light source and a coil connected to the light source are attached to the container; putting the food into the container; providing the cost with radio waves or an electromagnetic radiation; providing an electric current to the light source from the coil; and emitting sterilizing light from, the light source.

### BRIEF DESCRIPTION OF DRAWINGS

FIG. 1 shows a cross-sectional view of a device for preserving food having a plastic container and a photocatalyst layer.

FIG. 2 shows a circuit diagram of the device of preserving food.

FIG. 3 shows a spectrum of absorbance of particles.

FIG. 4 shows a cross-sectional view of a circuit board and the photocatalyst layer in the device for preserving food.

FIG. 5 shows a cross-sectional view of the device for preserving food having the plastic container and the photocatalyst layer.

FIG. 6 shows a cross-sectional view of a device for preserving food having a bottle.

FIG. 7 shows a cross-sectional view of a device for preserving food having a storage bag.

FIG. 8 shows a cross-sectional view of the device for preserving food having a light guiding plate.

FIG. 9 shows a cross-sectional view of the device for preserving food having the light guiding plate.

FIG. 10 shows a cross-sectional view of the device for preserving food having the light guiding plate.

FIG. 11 shows a cross-sectional view of the device for preserving food having an antenna and a storage unit.

FIG. 12 shows a cross-sectional view of the device for preserving food having a plurality of antennas and a storage unit.

FIG. 13 shows a cross-sectional view of the device for preserving food having a temperature sensor.

FIG. 14 shows a cross-sectional view of the device for preserving food having an ethylene sensor.

FIG. 15 shows a cross-sectional view of the device for preserving food having a radical sensor.

FIG. 16 shows a cross-sectional view of the device for preserving food having a door sensor.

FIG. 17 shows a cross-sectional view of a device for preserving food having a light source emitting sterilizing light.

FIG. 18 shows a cross-sectional view of the device for preserving food having the Sight source emitting sterilizing light.

FIG. 19 shows-a cross-sectional view of a device for preserving food having a bottle.

FIG. 20 shows a cross-sectional view of a device for preserving food having a storage bag.

FIG. 21 shows a cross-sectional view of the device for preserving food having a light guiding plate.

FIG. 22 shows a cross-sectional view of the device for preserving food having the light guiding plate.

FIG. 23 shows across-sectional view of the device for preserving food having the light guiding plate.

FIG. 24 shows a cross-sectional view of the device for preserving food having an antenna and a storage unit.

FIG. 25 shows a cross-sectional view of the device for preserving food having a temperature sensor.

FIG. 26 shows a cross-sectional view of the device for preserving food having an ethylene sensor.

FIG. 27 shows a cross-sectional view of the device for preserving food having a radical sensor.

FIG. 28 shows a cross-sectional view of the device for preserving food having a door sensor.

### DETAILED DESCRIPTION

In the following detailed description, reference is made to the accompanying drawings. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein, it will lie readily understood that the aspects of the present disclosure, as generally described herein, and illustrated in the drawings, can be arranged, substituted, combined, separated, and designed in a wide variety of different configurations, ail of which are explicitly contemplated herein.

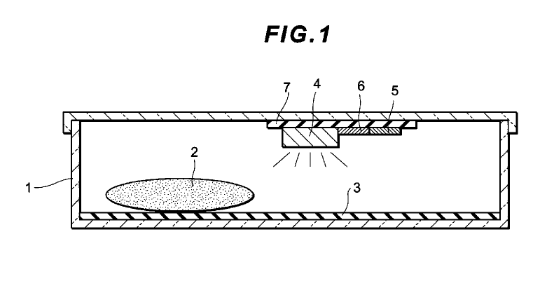

With reference to FIG. 1, a device for preserving food can include a container 1 configured to contain the food 2, a photocatalyst layer 3 disposed in the container 1, a light source 4 attached to the container 1, and a coil 5 attached to the container 1 and configured to receive radio waves or electromagnetic radiation and provide an electric current to the light source 4. The photocatalyst layer 3 generates a radical to preserve the food 2, when the photocatalyst layer 3 is exposed to light emitted by the light source 4.

The container 1 can include a cap. Examples of the container 1 include plastic cases and glass cases. Existing containers can be used as the container 1. When the coil 5 is disposed inside the container 1, as shown in FIG. 1, the container 1 can generally be made of any material that allows the radio waves or the electromagnetic radiation to transmit through, the wall of the container 1. When the light source 4 is disposed inside the container 1, the container 1 may be transparent or opaque.

Examples of the materials for the transparent plastic container 1 include polyethylene terephthalate (PET), polypropylene (PP), polystyrene (PS), phenol resin, urea resin, melamine, polyethylene (PE), poly(methyl methacrylate) (PMMA), nylon, polylactic acid, polymethylpentene, poly(vinyl alcohol) (PVA), polyvinyl chloride), polystyrene, poly(vinylidene chloride), polycarbonate, polyamide, polyimide, polyamide-imide, and fluorocarbon polymers such as poly chloro tri-fluoro ethylene (PCTFE), perfluoroalkoxy polymer resin (PPA), flouoronated ethylene propylene (PEP) and ethylene-terra fluoro ethylene (ETFE). In addition, transparent rubber such as nitrile rubber, styrenebutadiene-rubber, fluorocarbon rubber and silicon gum can be used as the materials for the container 1. Further, ionomer can be used as the materials for the container 1.

Examples of the materials for the opaque container 1 that allow the radio waves or the electromagnetic radiation to transmit through the wall of the container 1 include ceramic, paper, colored resin, styrene foam, laminated material, fiber, wood, animal skin, bark, clay and stone.

A thin layer of evaporated metal, such as aluminium or oxide such as silicon oxide (SiO₂) may be formed on the surface of the container 1 to inhibit a permeation of a gas.

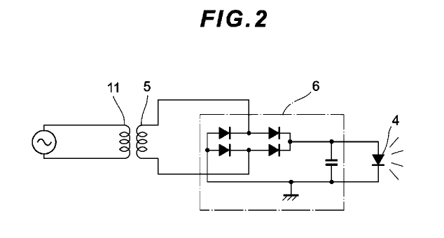

When the coil 5 is provided with the radio waves or the electromagnetic radiation, the coil 5 generates the electric current and provides it to the light source 4. A coil for a passive RFID (Radio Frequency Identification) IC tag can be used as the coil 5 without modification. A rectification circuit 6 may be connected between the coil 5 and the light source 4. An example of the light source 4 is a light emitting diode (LED) that consumes low power. FIG. 2 shows a circuit diagram including the coil 5, the rectification circuit 6, and the light source 4. As shown in FIG. 1, the coil 5, the rectification circuit 6, and the light source 4 may be formed in a print circuit, board 7.

The RFID IC tag contains a circuit having a coil and a rectification circuit. Therefore, it is possible to modify the circuit for the RFID IC tag to manufacture the print circuit board 7 having the light source 4. The print circuit board 7 can be manufactured by printing circuit elements on a polyimide substate or a film. For example, the print circuit board 7 manufactured by printing the circuit elements on the film is thin and makes it possible to reduce the size of the container 1.

At least a portion of the print circuit board 7 including the coil 5, the rectification circuit 6 and the light source 4 may be protected by a moistureproof film. The moistureproof film may be transparent to the light emitted from the light source 4.

The print circuit board 7 may be bonded to the container i by an adhesive or a welding. An example of the adhesive is an adhesive tape having a removable release liner. The adhesive tape may be firstly put on the print circuit board 7. Thereafter, the release liner may be removed from the adhesive tape and the print circuit board 7 may be put on the container 1. A low-tack adhesive allows the print circuit hoard 7 to easily be attached and removed. By using the low-tack adhesive, tire print circuit board 7 can be reusable on other containers. When the device disclosed herein is discarded, the print circuit board 7 containing metals may be separated from the container 1 and the print circuit board 7 and the container 1 may be collected separately.

When the electric current is provided, the light source 4 emits light including ultraviolet light and visible light. The wavelength of the light varies depending on the absorption band of the photocatalyst layer 3. The visible light may be convenient since users can easily confirm that the light source 4 emits the light. An example of the light source 4 emitting the visible light is an indium gallium nitride (InGaN) LED emitting purple light having a wavelength of 450 nm. When the light is emitted from the light source 4, the photocatalyst layer 3 generates the radical. An example of the radical is a reactive oxygen species such as a hydroxyl radical.

An ethylene gas may be emitted from the foods 2 such as apples, avocados, bananas, pears, peaches, plums, cantaloupes, honey dew melons, mushrooms, and tomatoes. Vegetables that absorb ethylene include brassicas, leafy greens, beans, carrots, cucumbers, eggplant, peas, peppers and potatoes.

Ethylene serves as a hormone in plants and destroys the freshness of the fruits and the vegetables. Some of the effects of ethylene exposure are pitting and russeting on string beans and lettuce, the yellowing of broccoli buds, cucumbers, Brussels sprouts and bitterness in carrots. In addition, microorganisms may multiply from foods 2 such as meat and fish. However, the radical generated by the photocatalyst layer 3 can degrade the ethylene gas and kill the microorganisms. It should be noted that, since the radical is promptly decomposed, the device disclosed herein is harmless to humans. The device disclosed herein is safe and has a low environmental load compared with various other agents and additives.

The photocatalyst layer 3 may include a binder polymer and a plurality of photo-catalyst particles dispersed in the binder polymer. An Example of the binder polymer is an inorganic polymer. The photocatalyst particles may absorb the light emitted by the light source 4 and may decompose water to generate the reactive oxygen species. Moisture content in the food 2 can be used to generate the reactive oxygen species. When the moisture content in the food 2 is increased, the food 2 may be easy to spoil, However, when, the moisture content in the food 2 is increased, the reactive oxygen species generated from the photocatalyst layer 3 is also increased. Therefore, the photocatalyst layer 3 can maintain, the freshness of the food 2 even if the moisture content in the food 2 is increased. In addition, when the food 2 is irradiated with the strong light other than the light emitted from the light source 4, the food 2 may be easy to spoil. However, when the photocatalyst layer 3 is irradiated with the strong light, the photocatalyst layer 3 can generate, a large amount of the reactive oxygen species. Therefore, the photocatalyst layer 3 can maintain the freshness of the food 2 even if the container 1 is left beneath a strong light source.

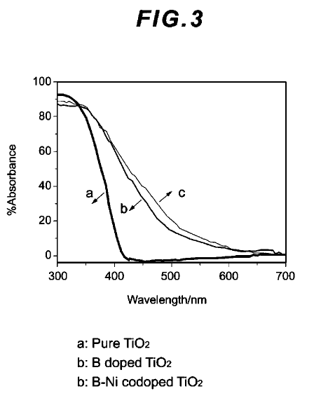

Examples of the photocatalyst particles are titanium oxide (TiO₂) that absorbs UV light having a wavelength of less than 380 nm, boron doped titanium oxide (B doped TiO₂) and boron nickel codoped titanium oxide (B—Ni codoped TiO₂) that absorbs visible purple light having a wavelength of about 450 nm. FIG. 3 shows an example of the spectrum of the photocatalyst particles,

In addition, examples of the photocatalyst particles include strontium titanate (SrTiO₃), tungsten oxide (WO₃), WO₃ doped with palladium (Pd), WO, doped with copper (Cu), zinc oxide (ZnO), tin dioxide (SnO₂), zirconium dioxide (ZrO₂), Bismuth oxide (Bi₂O₃), iron oxide (Fe₂O₃), silver gallium oxide (AgGaO₂), calcium bismuth oxide (CaBi₂O₄), Cr—Ba₂In₂O₅/In₂O₃, RuO₂—ZnGa₂O₄, GaN—ZnO, RuO₂/Ge₃N₄. ZnS—CuInS₂—AgInS₂, HNb₂O₈ doped with N, NaTaO₃, NaTaO₃ doped with lanthanides (La, Pr, Nd, Sin, Gd, Tb, Dy), NaTaO₃ doped with lanthanides and N, and TaO₄ doped with In and Ni.

Dolomite or palladium may be added into the photocatalyst layer 3 shown in FIG. 1 to increase efficiency of the photocatalyst particles that generate the radicals. Since the efficiency of the photocatalyst is increased by dolomite or palladium, the number of the light source 4 can be reduced and thereby the energy consumption can be reduced.

The photocatalyst layer 3 may be formed by coating or spraying a solution including the binder polymer and the particles on interior surfaces of the container 1. In another embodiment, the photocatalyst layer 3 may be bonded to the interior surfaces of the container 1 by an adhesive or a welding. An example of the adhesive is an adhesive tape having a removable release liner. The adhesive tape may be firstly put on the interior surfaces of the container 1. Thereafter, the release liner may be removed from the adhesive tape and the photocatalyst layer 3 may be put on the surface of the adhesive tape. The photocatalyst layer 3 can be reusable on other containers.

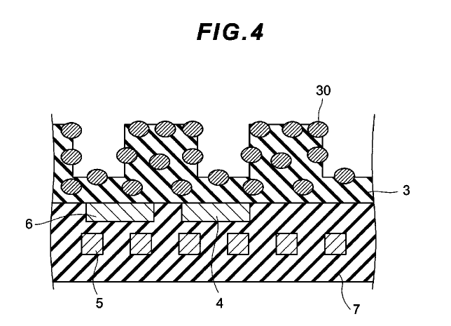

Alternatively, as shown in FIG. 4, the photocatalyst layer 3 may be formed on the print circuit board 7. Even if the binder polymer has worn down, the dispersed photo-catalyst particles 30 may appear on the surface of the photocatalyst layer 3. Therefore, it is possible to keep generating the radical.

The photocatalyst layer 3 may have a concavo-convex surface to increase surface area. The concavo-convex surface may scatter the light Since the scattered light is efficiently absorbed by the photocatalyst particles, the concavo-convex surface may increase the efficiency of the photocatalyst layer 3. A sectional, view of the concavo-convex surface is a rectangular shape, or a triangular shape, a wave shape, or a lens shape. Examples of the lens shape include a sphere lens shape, a spherical lens shape, a ball lens shape, an aspheric lens shape, a cylindrical lens shape, and a spherocylindrical lens shape. The concavo-convex surface may be formed by a gravure printing. Alternatively, the photocatalyst layer 3 may have a roughened surface. The roughened surface may also scatter the light. The roughened surface may be formed by a sandblast method.

Traditionally, a disposable ethylene absorber is used to preserve the foods. However, an absorption capacity of the ethylene absorber would be saturated. On the contrary, the capacity of the photocatalyst layer would not be saturated and lasts over an extended period of time. Therefore, the device disclosed herein can be used repeatedly. Thus, the device disclosed herein is economical and has a low environmental load. In addition, since the device disclosed herein utilizes a wireless power supply system, there is no need to pet a battery that may be harmful to humans into the container 1. Further, there is no need to form a hole for a wiring on the wall of the container 1. Therefore, it is possible to increase a sealing performance of the container 1. Accordingly, cleanliness and a temperature of the interior of the container 1 can be maintained.

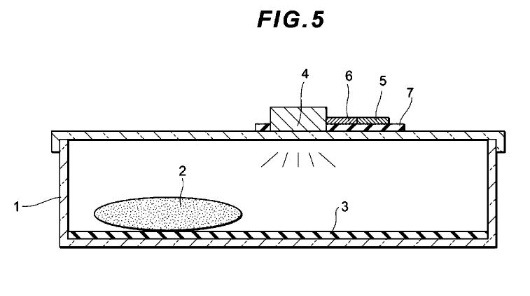

With reference to FIG. 5, the device for preserving food cat) include the coil 5 and the light source 4 disposed outside the container 1. For example, the coil 5 and the light source 4 are disposed on the outer surface of the cap of the container 1. When the light source 4 is disposed outside the container 1, the container 1 can generally be made of any material, that is transparent to the light emitted from the light source 4. In yet another embodiment, one of the coil 5 and the light source 4 may be disposed inside the container 1 and another may be disposed outside the container 1. Other components of the device shown in FIG. 5 are similar to the device shown in FIG. 1.

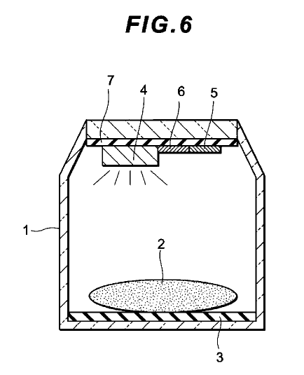

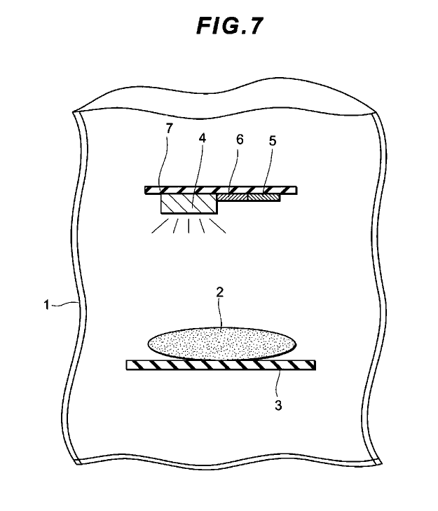

Various types of containers can be used for the device for preserving food. For example, bottles as shown in FIG. 6 and scalable storage bags as shown in FIG. 7 can be used as the container 1. Examples of the materials for the scalable storage bags include polyacryionitrile (PAN), ethylene-vinyl acetate copolymer (EVA), ethylene vinyl alcohol (copolymer) (EVOH), ethylene methacrylic acid (EMAA) and cellulose film. In addition, a cardboard can be used as the container 1.

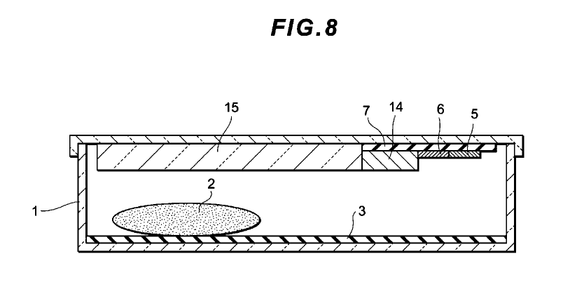

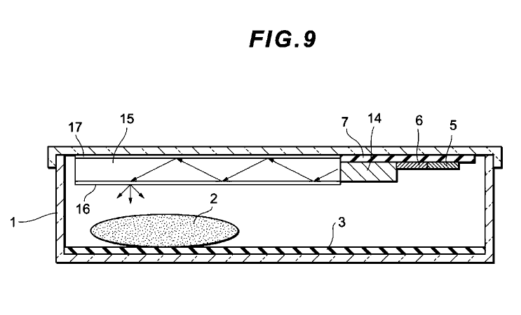

With reference to FIG. 8, the device for preserving food can further include a light guiding plate 15 for guiding the light into the container 1. The light guiding plate 15 may be disposed on the back surface of the cap of the container 1. Alternatively, the light guiding plate 15 is a part of the container 1. When the container 1 is flexible, the light guiding plate 15 may also be flexible. The light emitted by the light source 4 enters the edge of the light guiding plate 15. The light guiding plate 15 diffuses the light through a plurality of bumps. The bumps may be unevenly spaced and the density of the bumps increases away from the light source 4. As shown in FIG. 9, the device for preserving food can further include a reflector 17 and a prism sheet 16. The reflector 17 is disposed on the back surface of the light guiding plate 15. The reflector 17 reflects the light back to the light guiding plate 15. The prism sheet 16 concentrates the light towards the photocatalyst layer 3.

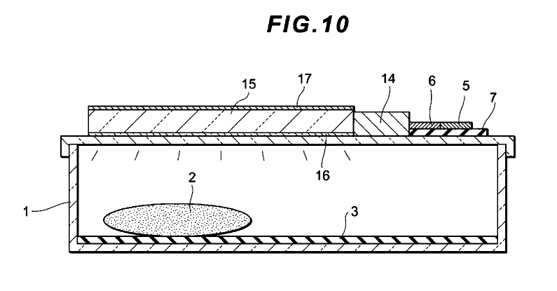

Alternatively, the light guiding plate 15 may be disposed on the outer surface of the cap of the container 1, as shown in FIG. 10.

Examples of the materials for the light guiding plate 15 and the prism sheet 16 include polyethylene terephthalate (PET), polypropylene (PP), polystyrene (PS), phenol resin, urea resin, melamine, polyethylene (PE), poly(methyl methacrylate) (PMMA), nylon, polylactic acid, polymethylpentene, polyvinyl alcohol) (PVA), poly(vinyl chloride), polystyrene, poly(vinylidene chloride), polycarbonate, polyamide, polyimide, polyamide-imide, and fluorocarbon polymers such as poly chloro-tri-fluoro ethylene (PCTPE), perfluoroalkoxy polymer resin (PFA), fluorinated ethylene propylene (PEP) and ethylene-tetra fluoro ethylene (ETFE). An example of the material for the reflector 17 is aluminum.

When the light source 4 is a point light source, a radiation field is small. However, the light source 4 and the light guiding plate 15 constitute a surface light source. Since a radiation field of the surface light source is large, the sufficient light can be irradiated on the photocatalyst layer 3. In addition, the light guiding plate 15 can reduce the number of the light source 4.

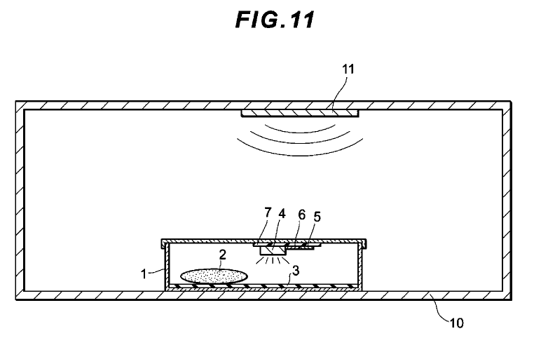

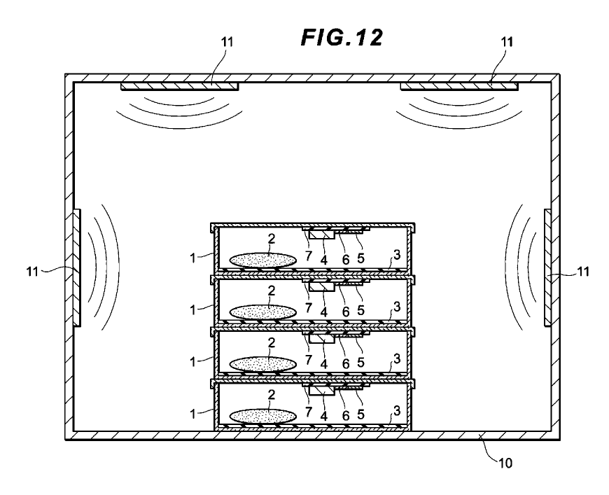

With reference to FIG. 11, the device for preserving food can further include an antenna 11 configured to provide the coil 5 with the radio waves or the electromagnetic radiation. The antenna 11 may be disposed outside the container 1 and inside a storage unit 10 for storing the container 1. Examples of the storage unit 10 are a refrigerator and a refrigerated counter. As shown in FIG. 12, a plurality of containers 1 may be stored in the storage unit 10 mid a plurality of antennas 11 are disposed in the storage unit 10. When the food 2 can be stored at room temperature, the container 1 and the antennas 11 may be disposed outside the storage unit 10.

An antenna coil for a passive RFID reader can be used as the antenna 11 without modification. For example, the antenna 11 transmits the radio waves or the electromagnetic radiation at Ultra-High Frequency (UHF) over several meters. Alternatively, the antenna 11 transmits wireless power via magnetic resonances or electromagnetic resonances. When the storage unit 10 is large, the distance from the single antenna 11 to each of the plurality of containers 1 may vary depending on the displacement of the containers 1, resulting in differences in the power received by the coils 5 in the containers 1. However, the plurality of antennas 11 symmetrically disposed at multiple sites may reduce the differences in the power received by the coils 5. Further, the plurality of antennas 11, may transmit the radio waves or the electromagnetic radiation in turns to reduce the differences in the accumulated power received by the coils 5. The antennas 11 may be connected to a 12-24 voltage 20-40 ampere direct current (DC) power supply, for example.

The device disclosed herein does not need wiring between the interior of the container 1 and the power supply. Therefore, an existing refrigerator can be used to manufacture the device disclosed herein by displacing the antenna 11 in the existing refrigerator. In addition, since the displacement of the container 1 is not limited by the wiring, the container 1 can be displaced anywhere inside the storage unit 10.

For example, freshness of the fruits and vegetables in the distribution channel can be maintained until the fruits and vegetables are delivered to homes by using the device disclosed herein without preservatives. While the fruits and vegetables are delivered to homes, the radio waves or electromagnetic radiation transmitted by the antenna 11 can be remotely controlled depending on a food, temperature, moisture and transit time, in addition, if the plurality of containers 1 are stacked in the refrigerator as the storage unit 10, air circulation in the refrigerator may be blocked. However, since the device disclosed herein does not use the air circulation to preserve the foods 2, all of the foods 2 are sufficiently preserved.

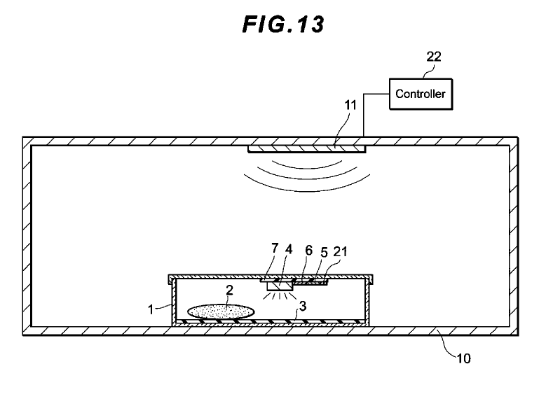

With reference to FIG. 13, the device for preserving food can further include a temperature sensor 21 and a controller 22 configured to control the radio waves or the electromagnetic radiation based on a temperature measured by the temperature sensor 21. The temperature sensor 21 may be disposed in the container 1 or may be disposed in the storage unit 10. The temperature sensor 21 may sense a temperature of the food 2. The temperature sensor 21 may wirelessly transmit the measured temperature to the controller 22. The controller 22 is electrically connected to the antenna 11. Examples of the controller 22 include a personal computer (PC) and a power line communication (PLC) apparatus.

High temperature and temperature change may induce the food 2 to emit the ethylene gas. Therefore, when the temperature sensor 21 senses that the temperature is above a predetermined value or that the temperature changes, the controller 22 may initiate a transmittance of the radio waves or the electromagnetic radiation from the antenna 11 or may intensify the radio waves or the electromagnetic radiation to generate the radicals from the photocatalyst layer 3 and rapidly degrade the ethylene gas in the container 1.

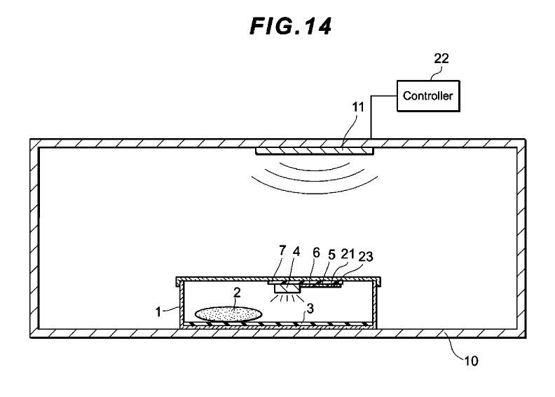

With reference to FIG. 14, the device for preserving food can further include an ethylene sensor 23 disposed in the container 1. The ethylene sensor 23 can include a quartz, oscillator and an ethylene gas adsorbent fixed on the quartz oscillator. An example of the ethylene gas adsorbent is ethylene monooxygenase. The controller 22 is configured to control the radio waves or the electromagnetic radiation based on the amount of ethylene measured by the ethylene sensor 23. The ethylene sensor 23 may wirelessly transmit the measured amount of ethylene to the controller 22.

When the ethylene sensor 23 senses that the amount of ethylene is above a predetermined value, the controller 22 may initiate a transmittance of the radio waves or the electromagnetic radiation from the antenna 11 or may intensify the radio waves or the electromagnetic radiation to generate the radicals from the photocatalyst layer 3 and rapidly degrade the ethylene gas in the container 1.

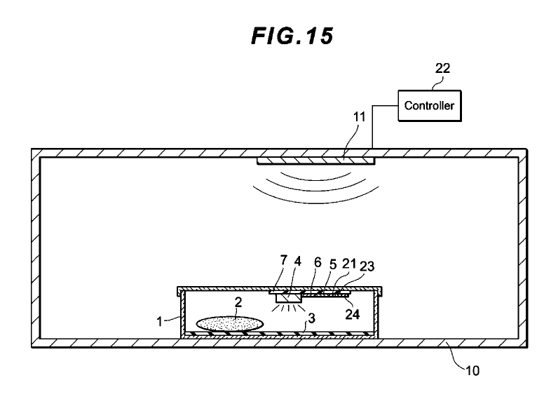

With reference to FIG. 15, the device for preserving food can further include a radical sensor 24 disposed in the container 1. The radical sensor 24 can include a tin oxide thin film. When the hydroxyl radical contacts with the tin oxide thin film, an electric resistance of the tin oxide thin film varies. Therefore, the amounts of radicals can be measured by monitoring the electric resistance of the tin oxide thin film included in the radical sensor 24. The controller 22 is configured to control the radio waves or the electromagnetic radiation based on the amount of radicals measured by the radical sensor 24. The radical sensor 24 may wirelessly transmit the measured amount of radicals to the controller 22.

When the radical sensor 24 senses that the amount of radicals is below a predetermined value, the controller 22 may initiate a transmittance of the radio waves or the electromagnetic radiation from the antenna 11 or may intensify the radio waves or the electromagnetic radiation to increase the radicals generated by the photocatalyst layer 3 in the container 3.

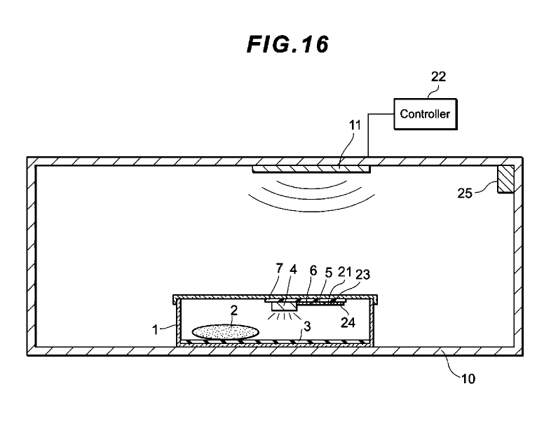

With reference to FIG. 16, the device for preserving food can further include a sensor 25 configured to sense an opening of a door of the storage unit 10. The controller 22 is configured to control the radio waves or the electromagnetic radiation when the sensor 25 senses the opening of the door. The sensor 25 may be electrically connected to the controller 22. Alternatively, the sensor 25 may be wirelessly connected to the controller 22.

When the door of the storage unit 10 is opened, a temperature inside the storage unit 10 is raised. In addition, microbes, funguses and viruses may enter the storage unit 10. Therefore, when the sensor 25 senses the opening of the door, the controller 22 may initiate a transmittance of the radio waves or the electromagnetic radiation from the antenna 11 or may intensify the radio waves or the electromagnetic radiation to generate the radicals from, the photocatalyst layer 3. The controller 22 may control the transmittance of the radio waves or the electromagnetic radiation for a while even after the door is closed.

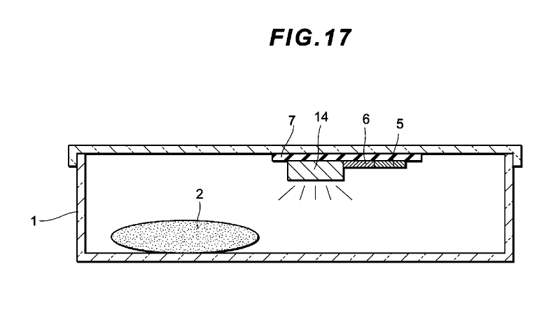

With reference, to FIG. 17, a device for preserving food can include a container 1 configured to contain the food 2, a light source 14 attached to the container 1 and emitting sterilizing light, and a coil 5 configured to receive radio waves or an electromagnetic radiation and provide an electric current to the light source 14.

The container 1 can include a cap. Examples of the container 1 include plastic cases and glass cases. Existing containers can be used as the container 1. When the coil 5 is disposed inside the container 1, as shown in FIG. 17, the container 1 can generally be made of any material that allows the radio waves or the electromagnetic radiation to transmit through the wall, of the container 1. When the light source 14 is disposed inside the container 1, the container 1 may he transparent or opaque. A thin layer of evaporated metal such as aluminium or oxide such as silicon oxide (SiO₂) may be formed on the surface of the container 1 to inhibit a permeation of a gas.

When the coil 5 is provided with the radio waves or the electromagnetic radiation, the coil 5 generates the electric current and provides it to the light source 14. For example, the coil 5 can provide 1W of electric power to the light source 14. A coil for a passive. RFID IC tag can be used as the coil 5 without modification. A rectification circuit 6 may be connected between the coil 5 and the light source 14. An example of the light source 14 is a light emitting diode (LED) that consumes low power. As shown in FIG. 17, the coil 5, the rectification circuit 6, and the light source 14 may be formed in a print circuit board 7. Since the print circuit board 7 is thin and lightweight, the print circuit board 7 can be attached to the various types of the container 1.

When the electric current is provided, the light source 14 emits the sterilizing light. An example of the sterilizing light is the ultraviolet light. Ultraviolet C (UVC) having a wavelength of 280-100 nm is preferably used since the UVC has a strong sterilizing power. Examples of the light source 14 emitting the sterilizing light include a diamond LED, an InAlGaN quaternary mixed crystals LED and a hexagonal boron nitride LED, A forward voltage drop of these LFDs is 4.5-6.0 V, for example. For example, an electric current of about 200 mA may be provided to the diamond LED as the light source 14 to emit the UVC light having a light intensity of 0.1 mW that is sufficient to sterilize the food 2. The wireless power transmission system using the coil 5 may provide the diamond LED as the light source 14 with at) electric power of 0.12 W, for example.

Since deoxyribonucleic acid (DNA) absorbs light having a wavelength of 260 nm, direct DNA damage can occur in microbes, funguses and viruses when the microbes, the funguses and the viruses are irradiated with the ultraviolet light emitted from the light source 14. For example, it is possible to sterilize the food 2 without antibiotics by repeating irradiating the food 2 with the ultraviolet light having a wavelength of 235 nm for 10 seconds 10 times. A light intensity sufficient to sterilize the food 2 can be obtained by providing an electric current of 300 mA that corresponds to an electric power of about 0.1 mW to the diamond LED. Since the light source 14 is attached to the container 1, the light source 14 is closed to the food 2. Therefore, the ultraviolet light emitted from the light source 14 can efficiently kill the microbes, the funguses and the viruses in the food 2. In addition, resistant bacteria to the ultraviolet light could not be generated. When the container 1 is opaque to the ultraviolet light, the container 1 can protect the human eyes from the ultraviolet light inside tire container 1.

Water irradiated with the ultraviolet light can generate the hydroxyl radicals. Since the light source 14 is attached to the container 1, the light source 14 is closed to the water on the surface of the food 2 or dew condensation on the inside of the container 1. Therefore, the ultra violet light emitted from the light source 14 can efficiently generate the hydroxyl radicals from the water. As described above, the hydroxyl radicals can decompose ethylene gas into ethane and water. Accordingly, the light source 14 emitting the ultraviolet light can maintain the freshness of the food 2 such as the vegetables and the fruits.

At least a portion of the print circuit board including the coil 5, the rectification circuit 6 and the light source 14 may be protected by a moistureproof film. The moistureproof film may be transparent to the sterilizing light emitted from the light source 14. An example of the material for the moistureproof film is fluorinated ethylenepolypropylene that is transparent to the ultraviolet light,

The print circuit board 7 may be bonded to the container 1 by an adhesive or a welding. An example of the adhesive is an adhesive tape having a removable release liner. The adhesive tape may be firstly put on the print circuit, board 7. Thereafter, the release liner may be removed from the adhesive tape and the print circuit board 7 may be put on the container 1. A low-tack adhesive allows the print circuit board 7 to easily be attached and removed. By using the low-tack adhesive, the print circuit board 7 can be reusable on other containers. When the device disclosed herein is discarded, the print circuit board 7 containing metals may be separated from the container 1 and the print circuit board 7 and the container 1 may be collected separately.

As described above, the absorption capacity of the conventional ethylene absorber would be saturated. On the contrary, the light, source 14 can emit the ultraviolet light over an extended period of time. Therefore, it is possible to generate the hydroxyl radicals that degrades the ethylene over a long time by using the light source 14. Accordingly, the device disclosed herein can be used repeatedly. Thus, the device disclosed herein is economical and has a low environmental load. In addition, since the device disclosed herein utilizes a wireless power supply system, there is no need to put a battery that may be harmful to humans into the container 1. Further, there is no need to form a hole for a wiring on the wall of the container 1. Therefore, it is possible to increase a sealing performance of the container 1. Accordingly, cleanliness and a temperature of the interior of the container 1 can be maintained,

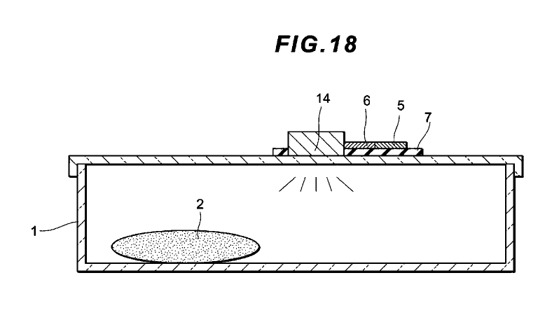

With reference to FIG. 18, the device for preserving food can include the coil 5 and the light source 14 disposed outside die container 1. For example, the coil 5 and the light source 14 are disposed on the outer surface of the cap of the container 1. When the light source 14 is disposed outside the container 1, the container 1 can generally be made of any material that is transparent to the sterilizing light emitted from the light source 14. In yet another embodiment, one of the coil 5 and the light source 14 may be disposed inside the container 1 and another may be disposed outside the container 1. Other components of the device shown in FIG. 18 are similar to the device shown in FIG. 17.

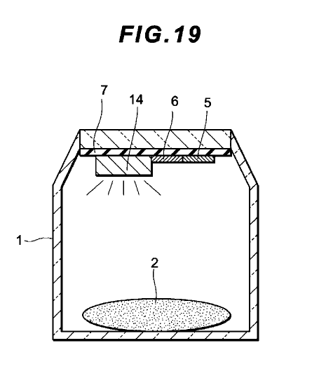

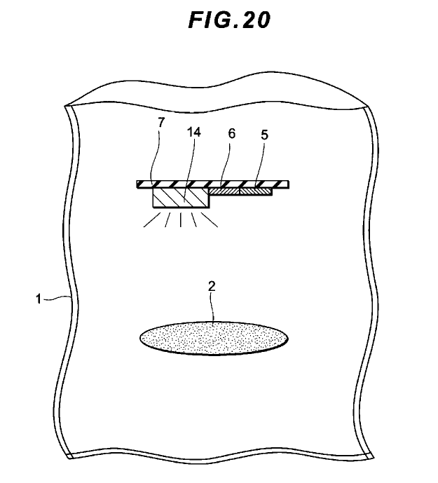

Various types of containers can lie used for the device for preserving food. For example, bottles as shown in FIG. 19 and scalable storage bags as shown in FIG. 20 can be used as the container 1. In addition, a cardboard can be used as the container 1.

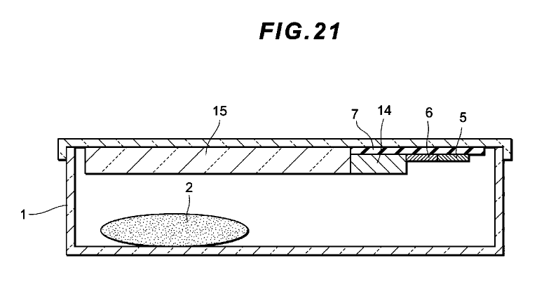

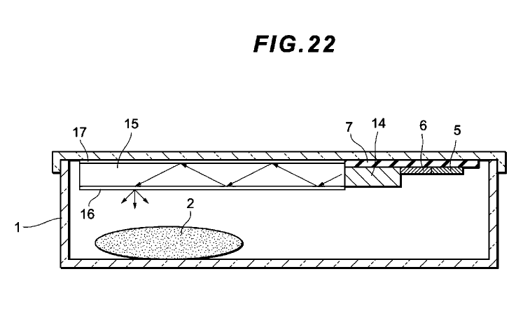

With reference to FIG. 21, the device for preserving food can further include a light guiding plate 15 for guiding the sterilizing light into the container 1. The light guiding plate 15 may be disposed on the back surface of the cap of the container 1. Alternatively, the light guiding plate 15 is a part of the container 1. When the container 1 is flexible, the light guiding plate 15 may also be flexible. The sterilizing light emitted by the light source 14 enters the edge of the light guiding plate 15. The light guiding plate 15 diffuses the sterilizing light through a plurality of bumps. The bumps may be unevenly spaced and the density of the bumps increases away from the light source 14. As shown in FIG. 22, the device for preserving food, can further include a reflector 17 and a prism sheet 16. The reflector 17 is disposed on the back surface of the light guiding plate 15. The reflector 17 reflects the sterilizing light back to the light guiding plate 15. The prism sheet 16 concentrates the sterilizing light towards the food 2.

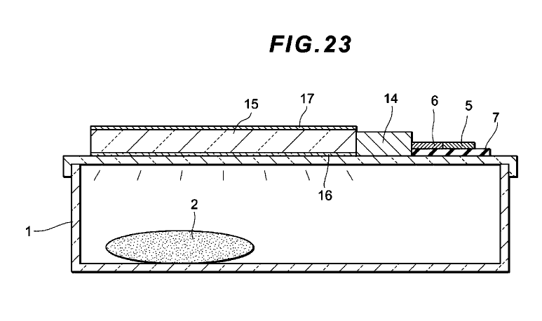

Alternatively, the light guiding plate 15 may foe disposed on the outer surface of the cap of the container 1, as shown in FIG. 23.

When the light source 14 is a point light source, a radiation field is small. However, the light source 14 and the light guiding plate 15 constitute a surface light source. Since the radiation field of the surface light source is large, the sufficient sterilizing light can be irradiated on the food 2. In addition, the light guiding plate 15 can reduce the number of the light source 14.

Infrared light and far infrared light can also be used as the sterilizing light. When the food 2 is irradiated with the infrared light or the far infrared light, the surface temperature of the food 2 is increased. Accordingly, the microbes, the funguses and the viruses in the food 2 can be killed by the heat. GaAS LED and AlGaAs LED can be used as the light source 14 for emitting the infrared light or the far infrared light.

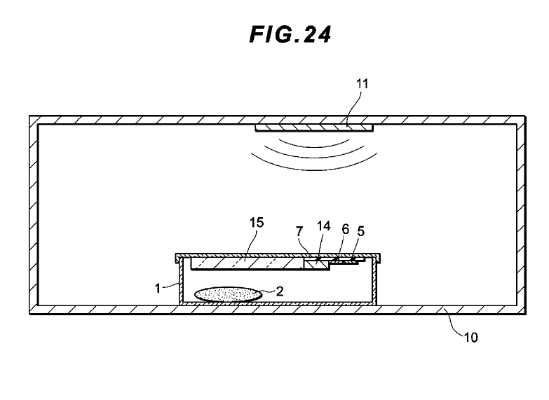

With reference to FIG. 24, a device for preserving food can further include an antenna 11 configured to provide the coil 5 with the radio waves or the electromagnetic radiation. The antenna 11 may be disposed outside the container 1 and inside a storage unit 10 for storing the container 1. Examples of the storage unit 10 are a refrigerator and a refrigerated counter. As described in example 4, an antenna coil for a passive RFID reader can be used as the antenna 11 without modification. For example, the antenna 11 transmits the radio waves or the electromagnetic radiation at Ultra-High Frequency (UHF) over several meters. Alternatively, the antenna 11 transmits wireless power via magnetic resonances or electromagnetic, resonances.

A long term irradiation of the ultraviolet light may heat the food 2. However, it is possible to maintain the food 2 at a constant temperature by irradiating the food 2 with the ultraviolet light, intermittently. The antenna 11 may be connected to a timer and the timer adjusts tire time at which the radio waves or the electromagnetic radiation is transmitted from the antenna 11.

The device disclosed herein does not need wiring between the interior of the container 1 and the power supply. Therefore, an existing refrigerator can be used to manufacture the device disclosed herein by displacing the antenna 11 in the existing refrigerator. In addition, since the displacement of the container 1 is not limited by the wiring, the container 1 can be displaced anywhere inside the storage unit 10.

For example, freshness of the fruits and vegetables in the distribution channel can be maintained until the fruits and vegetables are delivered to homes by using the device disclosed herein without preservatives. While the fruits and vegetables are delivered to homes, the radio waves or electromagnetic radiation transmitted by the antenna 11 can be remotely controlled depending on a food, temperature, moisture and transit time. In addition, if the plurality of containers 1 are stacked in the refrigerator as the storage unit 10, air circulation in the refrigerator may be blocked. However, since the device disclosed herein does not use the air circulation to preserve the foods 2, all of the foods 2 are sufficiently preserved.

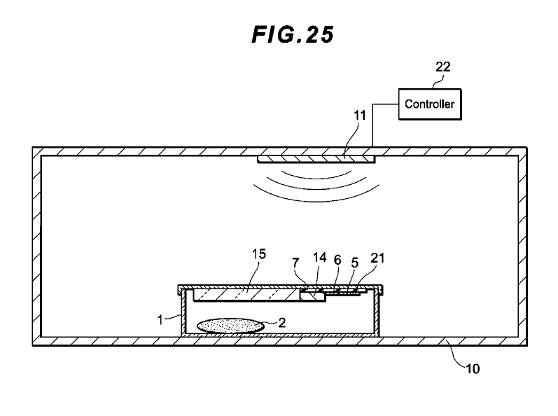

With reference to FIG. 25, the device for preserving food can further include a temperature sensor 21 and a controller 22 configured to control the radio waves or the electromagnetic radiation based on a temperature measured by the temperature sensor 21. High temperature and temperature change may proliferate the microbes, the funguses and the viruses in the container 1. Therefore, when the temperature sensor 21 senses that the temperature is above a predetermined value or that, the temperature changes, the controller 22 may initiate a transmittance of the radio waves or the electromagnetic radiation from the antenna 11 or may intensify the radio waves or the electromagnetic radiation to emit the sterilizing light from the light source 34 and kill the microbes, the funguses and the viruses in the container 1.

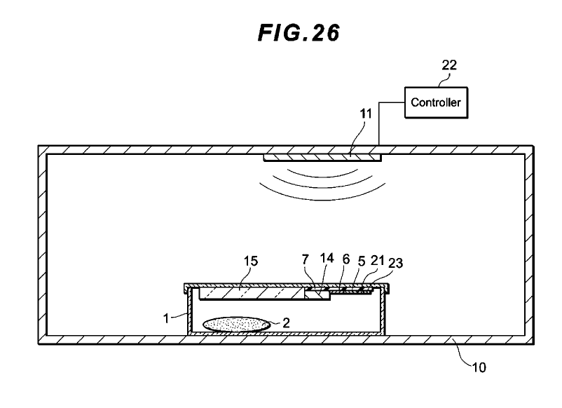

With reference, to FIG. 26, the device for preserving food can further include an ethylene sensor 23 disposed in the container 1. The controller 22 is configured to control the radio waves or the electromagnetic radiation based on the amount of ethylene measured by the ethylene sensor 23. When the ethylene sensor 23 senses that the amount of ethylene is above a predetermined value, the controller 22 may initiate a transmittance of the radio waves or the electromagnetic radiation from the antenna 11 or may intensify the radio waves or the electromagnetic radiation to emit the ultraviolet light from the light source 14. The water existing in the container 3 and irradiated with the ultraviolet light, can generate the hydroxyl radicals. The radicals rapidly degrade the ethylene gas in the container 1.

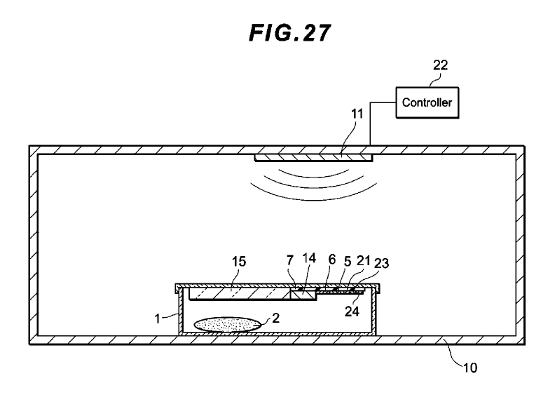

With reference, to FIG. 27, the device for preserving food can further include a radical sensor 24 disposed in the container 1. The controller 22 is configured to control the radio waves or the electromagnetic radiation based on the amount of radicals measured by the radical sensor 24. When the radical sensor 24 senses that the amount of radicals is below a predetermined value, the controller 22 may initiate a transmittance of the radio waves or the electromagnetic radiation from the antenna 11 or may intensify the radio waves or the electromagnetic radiation to emit the ultraviolet light from the light source 14. The hydroxyl radicals can be generated by the water existing in the container 1 and irradiated with the ultraviolet light.

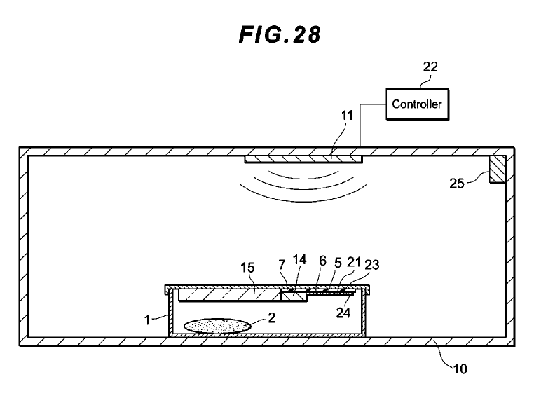

With reference to FIG. 28, the device for preserving food can further include a sensor 25 configured to sense an opening of a door of the storage unit 10. The controller 22 is configured to control the radio waves or the electromagnetic radiation when the sensor 25 senses the opening of the door. When the door of the storage unit 10 is opened, the microbes, the funguses and the viruses may enter the storage unit 10. Therefore, when, the sensor 25 senses the opening of the door, the controller 22 may initiate a transmittance of the radio waves or the electromagnetic radiation from the antenna 11 or may intensify the radio waves or the electromagnetic radiation, to emit the sterilizing light from the light source 14 and kill the microbes, the funguses and the viruses in the container 1. The controller 22 may control the transmittance of the radio waves or the electromagnetic radiation for a while even after the door is closed.

### EXAMPLES

### Example 1

### Storing Fruits and Vegetables While Preserving Freshness by Using Radicals

Farmers can store fruits and vegetables in a container having a photocatalyst, a light source, and a coil connected to the light source. The farmers can provide the coil with radio waves or an electromagnetic radiation to provide an electric current to the light source from the coil. Thereby, the light source emits a light to generate radicals from the photocatalyst layer. Since the radicals can degrade ethylene gas, the farmers can store the fruits and vegetables while preserving freshness until the fruits and vegetables are shipped to a market.

### Example 2

### Storing Fishes While Preserving Freshness by Using Radicals

Fishermen can store fishes in a container having a photocatalyst, a light source, and a coil connected to the light source. The fishermen can provide the coil with radio waves or an electromagnetic radiation to provide an electric current to the light source to generate radicals from the photocatalyst layer. Since the radicals can kill microorganisms, the fishermen can store the fishes while preserving freshness until the fishes are shipped to a market.

### Example 3

### Storing Meats While Preserving Freshness by Using Radicals

Livestock breeders can store meats in a container having a photocatalyst, a light source, and a coil connected to the light source. The livestock breeders can provide the coil with radio waves or an electromagnetic radiation to provide an electric current to the light source to generate radicals from the photocatalyst layer. Since the radicals can kill microorganisms, the livestock breeders can store the meats while preserving freshness until the meats are shipped to a market.

### Example 4

### Shipping Foods While Preserving Freshness by Using Radicals

Shipping agents can store foods in a container basing a photocatalyst, a light source, and a coil connected to the light source to degrade ethylene gas and kill microorganisms. Since the shipping agents can wirelessly provide an electric power to the light source, it is easy to ship the container. Therefore, the shipping agents can easily preserve the freshness of the foods in the container while shipping the foods.

### Example 5

### Displaying Foods in Market While Preserving Freshness by Using Radicals

Retailers can store foods in a transparent container having a photocatalyst, a light source, and a coil connected to the light source to degrade ethylene gas and kill microorganisms. Since the retailers can wirelessly provide an electric power to the light source, it is easy to displace the container in a refrigerated counter in a market and display the foods stored in the transparent container. Therefore, the retailers can easily preserve the freshness of the foods in the container while selling the foods.

### Example 6

### Storing Foods in House While Preserving Freshness by Using Radicals

Consumers can store foods in a container having a photocatalyst, a light source, and a coil connected to the light source to degrade ethylene gas and kill microorganisms. Since the consumers can wirelessly provide an electric power to the light source, it is easy to store the container in a refrigerator in their houses. Therefore, the consumers can easily preserve the freshness of the foods in the container until they cook the foods.

### Example 7

### Storing Fruits and Vegetables While Preserving Freshness by Using Sterilizing Light

Farmers can store fruits and vegetables in a container having a light source for emitting ultraviolet light as sterilizing light and a coil connected to the light source. The farmers can provide the coil with radio waves or an electromagnetic radiation, to provide an electric current to the light source from the coil. Thereby, the light source emits the ultraviolet light. The ultraviolet light can kill microorganisms. In addition, the ultraviolet light can generate hydroxyl radical from water. Since the hydroxyl radicals can degrade ethylene gas, the farmers can store the fruits and vegetables while preserving freshness until the fruits and vegetables are shipped to a market.

### Example 8

### Storing Fishes While Preserving Freshness by Using Sterilizing Light

Fishermen can store fishes in a container having a light source for emitting sterilizing light and a coil connected to the light source. The fishermen can provide the coil with radio waves or an electromagnetic radiation to provide an electric current to the light source to emit the sterilizing light. Since the sterilizing light can kill microorganisms, the fishermen can store the fishes while preserving freshness until the fishes are shipped to a market.

### Example 9

### Storing Meats While Preserving Freshness by Using Sterilizing Light

Livestock breeders can store meats in a container having a light, source for emitting sterilizing light and a coil connected to the light source. The livestock breeders can provide the coil with radio waves or an electromagnetic radiation to provide an electric current to the light source to emit the sterilizing light. Since the sterilizing light can kill microorganisms, the livestock breeders can store the meats while preserving freshness until the meats arc shipped to a market.

Example 10

### Shipping Foods While Preserving Freshness by Using Sterilizing Light

Shipping agents can store foods in a container having a light source for emitting sterilizing light and a coil connected to the light source to kill microorganisms. Since the shipping agents can wirelessly provide an electric power to the light source, it is easy to ship the container. Therefore, the shipping agents can easily preserve the freshness of the foods in the container while shipping the foods.

### Example 11

### Displaying Foods in Market While Preserving Freshness by Using Sterilizing Light

Retailers can store foods in a transparent container having a light source for emitting sterilizing light and a coil connected to the light source to kill microorganisms. Since the retailers can wirelessly provide an electric power to the light source, it is easy to displace the container in a refrigerated counter in a market and display the foods stored in the transparent container. Therefore, the retailers can easily preserve the freshness of the foods in the container while selling the foods.

### Example 12

### Storing Foods in House While Preserving Freshness by Using Sterilizing Light

Consumers can store foods in a container having a light source for emitting sterilizing light and a coil connected to the light source to kill microorganisms. Since the consumers can wirelessly provide an electric power to the light source, it is easy to store the container in a refrigerator in their houses. Therefore, the consumers can easily preserve the freshness of the foods in the container until they cook, the foods.

Modifications and variations of the embodiments described above would be thought of by those skilled in the art, in light of the above teachings. The scope of this disclosure is defined with reference to the following claims.

What is claimed is:

1. A device for preserving food, the device comprising:
a container configured to contain the food;
a photocatalyst layer disposed in the container;
a light source attached to the container; and
a coil configured to receive radio waves or an electromagnetic radiation and provide an electric current to the light source, the coil being attached to the container.

2. The device of claim 1, wherein the photocatalyst layer comprises a binder polymer and a plurality of photocatalyst particles dispersed in the binder polymer.

3. The device of claim 1, wherein the photocatalyst layer generates a radical when the photocatalyst layer is exposed to light emitted by the light source.

4.-5. (canceled)

6. The device of claim 1, wherein the photocatalyst layer comprises titanium oxide.

7.-12. (canceled)

13. The device of claim 1, further comprising a rectification circuit connected between the coil and the light source.

14.-15. (canceled)

16. The device of claim 1, further comprising a temperature sensor.

17. (canceled)

18. The device of claim 1, further comprising an ethylene sensor disposed in the container.

19. (canceled)

20. The device of claim 1, further comprising a radical sensor disposed in the container.

21.-22. (canceled)

23. The device of claim 1, further comprising:
an antenna configured to provide the coil with the radio waves or the electromagnetic radiation, the antenna being disposed outside the container;
a storage unit configured to store the container and the antenna; and
a sensor configured to sense an opening of a door of the storage unit.

24.-31. (canceled)

32. A method for preserving food, the method comprising:
providing a container wherein a photocatalyst is disposed in the container and a light source and a coil connected to the light source are attached to the container;
putting the food into the container;
providing the coil with radio waves or an electromagnetic radiation;
providing an electric current to the light source from the coil; and
emitting a light from the light source to generate a radical from the photocatalyst layer exposed to the light.

33.-35. (canceled)

36. The method of claim 32, wherein the photocatalyst layer comprises titanium oxide.

37.-42. (canceled)

43. The method of claim 32, wherein a rectification circuit is connected between the coil and the light source.

44.-46. (canceled)

47. The method of claim 32, further comprising measuring a temperature; and controlling the radio waves or the electromagnetic radiation based on the measured temperature.

48. (canceled)

49. The method of claim 32, further comprising measuring the amount of ethylene in the container; and controlling the radio waves or the electromagnetic radiation based on the amount of ethylene.

50. (canceled)

51. The method of claim 32, further comprising measuring the amount of radicals in the container; and controlling the radio waves or the electromagnetic radiation based on the amount of radicals.

52.-53. (canceled)

54. The method of claim 32, wherein the container is stored in a storage unit, and further comprising sensing an opening of a door of the storage unit; and controlling the radio waves or the electromagnetic radiation when the opening of the door is sensed.

55.-60. (canceled)

61. A device for preserving food, the device comprising:
a container configured to contain the food;
a light source attached to the container and emitting sterilizing light; and
a coil configured to receive radio waves or an electromagnetic radiation and provide an electric current to the light source, the coil being attached to the container.

62.-66. (canceled)

67. The device of claim 61, further comprising a rectification circuit connected between the coil and the light source.

68.-69. (canceled)

70. The device of claim 61, further comprising a temperature sensor.

71. (canceled)

72. The device of claim 61, further comprising an ethylene sensor disposed in the container.

73. The device of claim 72, further comprising a controller configured to control the radio waves or the electromagnetic radiation based on the amount of ethylene measured by the ethylene sensor.

74. The device of claim 61, further comprising a radical sensor disposed in the container.

75.-76. (canceled)

77. The device of claim 61, further comprising a radical sensor disposed in the container; a storage unit configured to store the container and the antenna; and a sensor configured to sense an opening of a door of the storage unit.

78.-85. (canceled)

86. A method for preserving food, the method comprising:
providing a container wherein a light source and a coil connected to the light source are
attached to the container;
putting the food into the container;
providing the coil with radio waves or an electromagnetic radiation;
providing an electric current to the light source from the coil; and
emitting sterilizing light from the light source.

87.-95. (canceled)

96. The method of claim 86, further comprising measuring a temperature; and controlling the radio waves or the electromagnetic radiation based on the measured temperature.

97. (canceled)

98. The method of claim 86, further comprising measuring the amount of ethylene in the container; and controlling the radio waves or the electromagnetic radiation based on the amount of ethylene.

99. (canceled)

100. The method of claim 86, further comprising measuring the amount of radicals in the container; and controlling the radio waves or the electromagnetic radiation based on the amount of radicals.

101.-102. (canceled)

103. The method of claim 86, wherein the radio waves or the electromagnetic radiation is provided by an antenna; the container and the antenna is stored in a storage unit; and further comprising sensing an opening of a door of the storage unit; and controlling the radio waves or the electromagnetic radiation when the opening of the door is sensed.

104.-109. (canceled)
